(19) United States
(12) Patent Application Publication
(10) Pub. No.: US 2016/0148167 A1
(43) Pub. Date: May 26, 2016

(54) METHOD AND APPARATUS FOR FACILITATING MEETING

(71) Applicant: NOKIA TECHNOLOGIES OY, Espoo (FI)

(72) Inventor: Xiaoping LI, Beijing (CN)

(73) Assignee: Nokia Technologies Oy

(21) Appl. No.: 14/900,598

(22) PCT Filed: Jun. 28, 2013
(86) PCT No.: PCT/CN2013/078325

§ 371 Date: Dec. 21, 2015

(51) Int. Cl. G06Q 10/10

(52) U.S. Cl. CPC G06Q 10/1095

(57) ABSTRACT

A method, apparatus and computer program product are provided in order to facilitate a meeting of a plurality of participants. In the context of a method, an estimated time of arrival is determined for one or more participants to a meeting. For example, the estimated time of arrival may be determined based upon a current location of a respective participant and/or a mode of transportation for the respective participant. The method may also include automatically causing information relating to the estimated time of arrival of the one or more participants to be provided to another party, such as one or more other participants in the meeting and/or an organizer of the meeting. A corresponding apparatus and a computer program product are also provided.

### TECHNOLOGICAL FIELD

Examples of embodiments of the present invention relate generally to a method, apparatus and computer program product for facilitating a meeting and, more particularly, but not exclusively, to a method, apparatus and computer program product for sharing information relating to the estimated time of arrival of one or more participants to a meeting.

### BACKGROUND

People regularly schedule meetings for a wide variety of purposes, including meetings scheduled for personal reasons, professional reasons or otherwise. For example, a person may schedule a meeting with a relative or a friend in order to meet for drinks or for dinner. As another example, meetings may be scheduled for business purposes in order to discuss a new project, to meet with a client or perspective customer or the like.

By its very nature, a meeting has two or more participants. In some instances, the participants must come from other locations, such as their home or their office in order to meet at a designated location. Because of traffic congestion, scheduling conflicts, general tardiness or the like, one or more of the participants in a meeting may sometimes arrive late for the meeting or relatively later with respect to one or more earlier arriving participants. Particularly in instances in which the participant who is arriving late is the meeting organizer or a key participant in the meeting, the meeting itself may be delayed until the tardy participant has arrived. While awaiting the arrival of the tardy participant, the other participants may attempt to contact the late arriving participant, such as by telephone, text or the like, in an effort to ensure that the late arriving participant is intending to join the meeting and, if so, to determine when the participant will likely arrive at the meeting. Even if the late arriving participant is able to provide an update as to their likely time of arrival, the other meeting participants may be forced to idly wait until the tardy participant's arrival, which may prove frustrating and inefficient.

### BRIEF SUMMARY

A method, apparatus and computer program product are provided in order to facilitate a meeting of a plurality of participants. In this regard, a method, apparatus and computer program product are provided in accordance with an example embodiment in order to share information regarding the estimated time of arrival of one or more participants to a meeting. As such, the participants may better judge the time at which a meeting will begin so as to more efficiently utilize their time prior to the commencement of the meeting. Additionally, the method, apparatus and computer program product of an example embodiment may facilitate a change to the meeting, such as a change to the location of the meeting, in an instance in which at least one of the participants is estimated to arrive late to the meeting in order to allow the meeting to commence in a manner that may reduce the delay otherwise caused by the late arrival of a participant to the meeting. In this way, a meeting organizer may monitor dynamically the estimated arrival times of participants at a meeting to which the participants have accepted invitations from the organizer. Alternatively, or in addition, one or more participants may be able to dynamically monitor estimated arrival times of at least one other participant (who may be the meeting organizer). If the estimated time of arrival of one or more of participants exceeds a threshold, a visual and/or audible or vibrational alert may be communicated to at least one other participant (who may be the meeting organizer).

In one aspect, a method is provide for determining an estimated time of arrival of one or more participants to a meeting. For example, the estimated time of arrival may be determined based upon a current location of a respective participant and/or a mode of transportation for the respective participant. Although the estimated time of arrival may be determined for each of the participants of a meeting, the method of an example embodiment may determine the estimated time of arrival for a subset of the participants in the meeting, such as a meeting organizer and/or one or more key participants in the meeting. The method may also include automatically causing information relating to the estimated time of arrival of the one or more participants to be provided to another party, such as one or more other participants in the meeting and/or an organizer of the meeting.

The method of an example embodiment may automatically cause information relating to the estimated time of arrival to be provided by causing information configured to cause a ticker notification to be displayed to be provided to the another party so as to provide the estimated time of arrival of the one or more participants to the another party. The method of an example embodiment may also automatically cause information relating to the estimated time of arrival to be provided by causing information defining a map including indications of respective locations of the one or more participants to be provided to the another party. In an example embodiment, the method may also include causing a suggestion for an alternative meeting location to be provided in an instance in which the estimated time of arrival of a participant is later than the starting time of the meeting. In this embodiment, the method may determine the alternative meeting location based upon respective locations of the participants in the meeting.

In another aspect, an apparatus is provided that includes a processor and a memory including computer program code with the memory and computer program code configured to, with the processor, cause the apparatus to determine an estimated time of arrival for one or more participants to a meeting. While the time of arrival may be determined for each of the participants, the memory and the computer program code may be configured to, with the processor, cause the apparatus of an example embodiment to determine the estimated time of arrival for a subset of the participants in the meeting, such as the meeting organizer and/or one or more key participants. The estimated time of arrival may be determined in an example embodiment based upon a current location of the respective participants and/or a mode of transportation for the respective participants. The memory and the computer program code are also configured to, with the processor, cause the apparatus to automatically cause information relating to the estimated time of arrival of the one or more participants to be provided to another party, such as an organizer of the meeting and/or one or more other participants in the meeting.

The memory and computer program code may be configured to, with the processor, cause the apparatus of an example embodiment to automatically cause information relating to the estimated time of arrival to be provided by causing information configured to cause a ticker notification to be displayed to be provided to the another party to provide the estimated time of arrival of the one or more participants to the another party. The memory and the computer program code may also be configured to, with the processor, cause the apparatus of an example embodiment to automatically cause information relating to the estimated time of arrival to be provided by causing information defining a map including indications of respective locations of the one or more participants to be provided to the another party. In an example embodiment, the memory and the computer program code may be further configured to, with the processor, cause the apparatus to cause a suggestion for an alternative meeting location to be provided in an instance in which the estimated time of arrival of a participant is later than the starting time of the meeting. The alternative meeting location may be determined based upon the respective locations of the participants in the meeting.

In a further aspect, a computer program product is provided that includes a non-transitory computer readable medium having program code portions stored therein with the program code portions configured, upon execution, to determine an estimated time of arrival for one or more participants to a meeting. The estimated time of arrival for each of the one or more participants may be based upon, for example, a current location of the respective participants and/or a mode of transportation for the respective participants. The program code portions are also configured to automatically cause information relating to the estimated time of arrival of the one or more participants to be provided to another party, such as the meeting organizer and/or one or more other participants in the meeting.

The program code portions configured to automatically cause information relating to the estimated time of arrival to be provided may include program code portions configured to cause a ticker notification to be displayed to be provided to the another party to provide the estimated time of arrival of the one or more participants to the another party. The program code portions configured to automatically cause information relating to the estimated time of arrival to be provided may include, in an example embodiment, program code portions configured to cause information defining a map including indications of respective locations of the one or more participants to be provided to the another party. In an example embodiment, the program code portions may be further configured to cause a suggestion for an alternative meeting location to be provided in an instance in which the estimated time of arrival of a participant is later than a starting time of the meeting. The alternative meeting location may be determined based upon respective locations of the participants in the meeting.

In yet another aspect, an apparatus is provided that includes means for determining an estimated time of arrival for one or more participants to a meeting. The estimated time of arrival may be determined based upon, for example, a current location of the respective participant and/or a mode of transportation for the respective participant. The apparatus also includes means for automatically causing information relating to the estimated time of arrival of the one or more participants to be provided to another party, such as a meeting organizer and/or one or more key participants in the meeting.

The means for automatically causing information relating to the estimated time of arrival to be provided may include means for causing information configured to cause a ticker notification to be displayed to be provided to the another party to provide the estimated time of arrival for the one or more participants to the another party. The means for automatically causing information relating to the estimated time of arrival to be provided may also include means for causing the information defining a map including indications of respective locations of the one or more participants to be provided to the another party. In an example embodiment, the apparatus may also include means for causing a suggestion for an alternative meeting location to be provided in an instance in which the estimated time of arrival of a participant is later than the starting time of the meeting. In this regard, the apparatus may include means for determining the alternative meeting location based upon respective locations of the participants in the meeting.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of an apparatus that may be specifically configured in accordance with an example embodiment of the present invention;

FIG. 2 is a flowchart illustrating operations performed, such as by the apparatus of FIG. 1, in accordance with an example embodiment of the present invention;

FIG. 3 illustrates the display of a schedule including a meeting at 9:00 a.m. at corporate headquarters (HQ);

FIG. 4 illustrates the display of information relating to the estimated time of arrival of the participants to the meeting in accordance with an example embodiment of the present invention;

FIG. 5 illustrates the display of a map depicting the respective locations of the participants in a meeting in accordance with an example embodiment of the present invention;

FIG. 6 illustrates the display of a suggestion for an alternative meeting location in accordance with an example embodiment of the present invention; and

FIG. 7 illustrates the display of a map depicting the respective locations of the participants in the meeting and the alternative location for the meeting in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in order to facilitate the organization of and commencement of a meeting. In this regard, the method, apparatus and computer program product may cause information relating to the estimated time of arrival of one or more participants to a meeting to be shared with another party, such as the meeting organizer who created or otherwise organized the meeting, such as by creating the meeting event in a calendar application, and/or one or more other participants in the meeting. As such, the participants in the meeting may be better informed as to the time at which all of the participants or at least all of the key participants will be assembled for the meeting and may potentially be able to make more efficient use of their time while awaiting commencement of the meeting. In some examples of embodiments, the method, apparatus and computer program product may facilitate re-scheduling to avoid inconvenience and/or the establishment of an alternative location for the meeting in an effort to reduce the delay associated with the commencement of a meeting in an instance in which one or more participants will be late for the meeting as originally scheduled and/or provide an indication of an alternative method of participation to one or more participants, such as, for example, by automatically generating a meeting update request to join the meeting on-line or via telephone which can be suitably communicated to a participant who is too delayed to join a meeting at the scheduled starting time, for example, via a short message service (SMS) message, a multimedia messaging service (MMS) message, an e-mail or an e-calendar invitation. If a participant is capable of being accurately located, the method, apparatus and computer program product of an example embodiment may be configured to provide information to the participant as to the type of communications that are enabled for remote participation in the meeting, such as by causing the information to be displayed on one or more remotely addressable display screens that are determined to be in the proximity of the participant so as to attract one or more participant's attention about the meeting and/or to provide meeting update information with any change of meeting location and/or timing

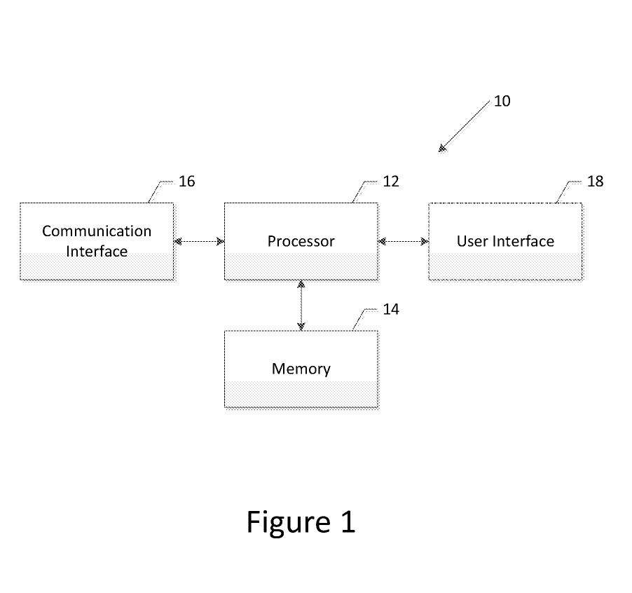

Referring now to FIG. 1, an apparatus 10 that may be specifically configured in accordance with example embodiment of the present invention is illustrated. The apparatus may be embodied by or associated with a user device associated with any one or more of the participants in the meeting and/or the meeting organizer In this regard, the user devices of the participants in the meeting and/or the meeting organizer may include mobile terminals, such as such as a portable digital assistant (PDA), mobile telephone, smartphone, pager, mobile television, gaming device, laptop computer, camera, tablet computer, headset, touch surface, video recorder, audio/video player, radio, electronic book, positioning device (e.g., global positioning system (GPS) device), or any combination of the aforementioned, and other types of voice and text communications systems, or other computing devices, such as fixed computing devices, e.g., a desktop computer, a personal computer or the like. Additionally or alternatively, the apparatus may be embodied by a server or other network computing device that is configured to provide the information to the user devices associated with one or more of the participants in the meeting and/or the meeting organizer. Still further, the apparatus of FIG. 1 may be deployed in a distributive manner and may be embodied by one or more user devices of the participants in the meeting and/or the meeting organizer and/or a server or other network computing device.

Regardless of the manner in which the apparatus 10 of FIG. 1 is embodied, the apparatus may include or otherwise be in communication with a processor 12, a memory device 14, a communication interface 16 and optionally a user interface 18. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 10 may be embodied by a user device, such as a mobile terminal or a fixed computing device, or a server or other network computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 12 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 12 may be configured to execute instructions stored in the memory device 14 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 16 may be any means such as a device or circuitry embodied in either hardware or a combination of hardware and software that is configured to receive and/or transmit data, such as from/to a network in an embodiment in which the apparatus 10 is embodied or otherwise associated with a user device or from/to one or more user devices in an embodiment in which the apparatus is embodied or otherwise associated with a server or other network computing device. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, such as in instances in which the apparatus 10 is embodied by a user device, the apparatus includes a user interface 18 that may, in turn, be in communication with the processor 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a speaker, or other input/output mechanisms. In one embodiment, the user interface includes the display upon indications of a plurality of tasks are presented, as described below. Alternatively or additionally, the processor may comprise user interface circuitry configured to control at least some functions of one or more user interface elements such as a display and, in some embodiments, a speaker, ringer, one or more microphones and/or the like. The processor and/or user interface circuitry comprising the processor may be configured to control one or more functions of one or more user interface elements through computer program instructions (e.g., software and/or firmware) stored on a memory accessible to the processor (e.g., memory device 14, and/or the like).

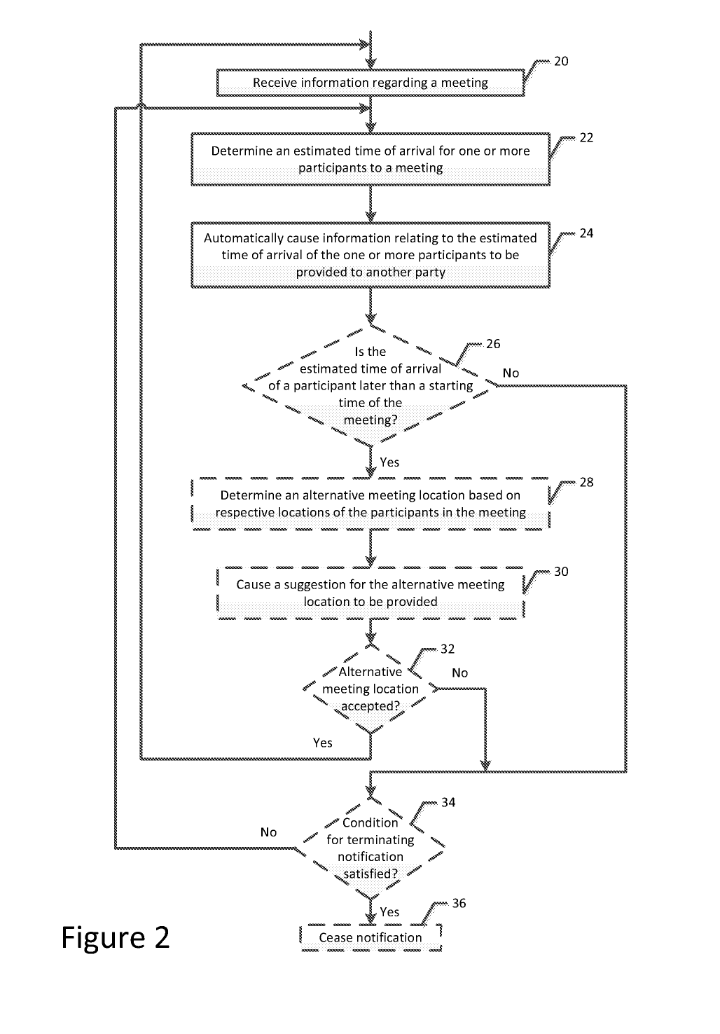

In order to facilitate the organization and/or commencement of a meeting, the operations performed, such as by the apparatus 10 of FIG. 1, in accordance with an example embodiment are illustrated in FIG. 2. As set forth by block 20 of FIG. 2, the apparatus may include means, such as the processor 12, communications interface 16, the user interface 18 or the like, for receiving information regarding a meeting. The information regarding a meeting may be received in various manners. For example, the information may be provided via a participant in the meeting via the user interface, such as in conjunction with the creation of an appointment in a scheduling application. Alternatively, the information regarding the meeting may be received via an invitation to the meeting that is received from a meeting organizer or another participant in the meeting. For example, the information may be received from a calendar invitation that is received and is accepted for placement within a scheduling application. Alternatively, the information may be received by extracting the information regarding a meeting from electronic messages, such as an email, a SMS message, an MMS message, a text message or the like, that are exchanged with the meeting organizer or another participant in the meeting.

Regardless of the manner in which the information regarding the meeting is received, the information may relate to a variety of different types of meetings. For example, the meeting may be related to business purposes, personal purposes or the like. For example, the meeting may be arranged for business purposes so that multiple employees may gather at a designated time and place in order to discuss a particular topic. Alternatively, the meeting may be arranged between friends, relatives or the like for personal purposes, such as to meet at a park, to meet for dinner, to meet to go shopping or the like.

Additionally, the information that is received regarding the meeting may vary depending upon the type of meeting and the information that is required and/or advantageous to share in advance in order to facilitate preparation for and attendance at the meeting. For example, the information may include information regarding the day and time at which the meeting will be conducted. With respect to some meetings, such as those arranged for business purposes, the subject matter of the meeting may be shared. The information that is received may also include an identification of the other participants in the meeting and/or the meeting organizer. In some instances, the information that is received regarding a meeting may include the location of the meeting, such as the address, the building name, the room number or the like. In other instances, the location of the meeting need not be included within the information regarding the meeting, such as in instances in which two or more friends or relatives are going to meet one another at a particular day and time, but at a location to be determined.

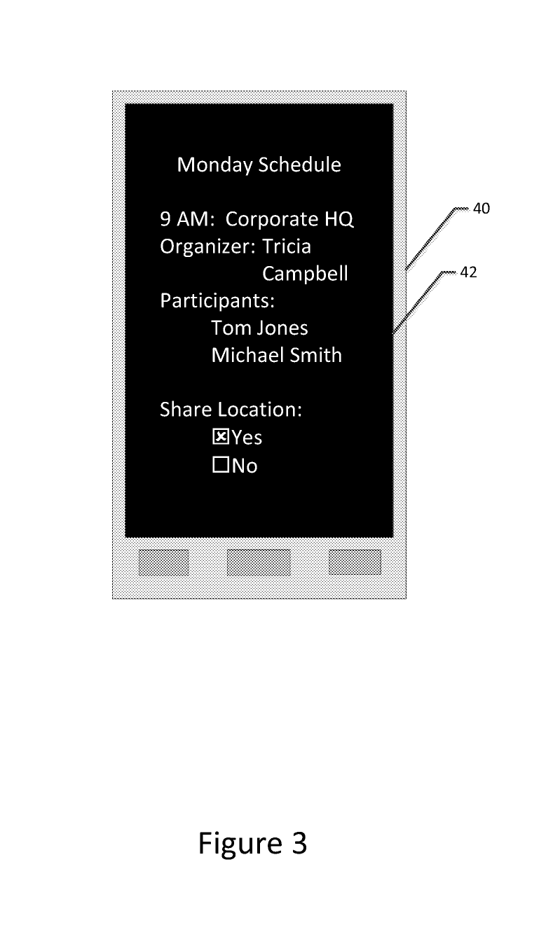

Referring now to FIG. 3, an example of the information that may be received regarding a meeting is depicted in conjunction with the display provided by a scheduling application. In this regard, a mobile terminal 40 may include a display 42 upon which the Monday schedule for a particular user is presented. As shown, the user is scheduled to participate in a meeting a corporate headquarters at 9:00 AM. The information associated with the meeting identifies the organizer to be Tricia Campbell and the other participants to be Tom Jones and Michael Smith. In an example embodiment, the information regarding the meeting may also include an indication provided by the participant as to whether the participant is willing to share information regarding their location, such as in advance of the scheduled meeting. The permission to share the location information may, in one embodiment, be a limited permission that only permits location information to be shared with the other participants and/or the meeting organizer for a limited period of time in advance of and during the meeting. Alternatively, the apparatus 10 may be configured such that a participant had to agree to share their location as a prerequisite to enjoying the benefits of the method, apparatus and computer program products of example embodiments of the present invention such that the participant need not be quizzed regarding the acceptability of their location being shared as shown in FIG. 3.

As shown in block 22 of FIG. 2, the apparatus 10 may also include means, such as the processor 12 or the like, for determining an estimated time of arrival for one or more participants to a meeting. The apparatus, such as the processor, may be configured to determine the estimated time of arrival of one or more participants to the meeting in advance of the starting time of the meeting, such as beginning a predetermined period of time in advance of the starting time of the meeting. The apparatus, such as the processor, may determine the estimated time of arrival of a respective participant based upon the current location of the participant. The current location of the participant may be determined in various manners. For example, analogous to the manners which a participant themselves may determine if they are going to be late for the meeting, the participant's device may determine its location using any suitable method such as but not limited to location information provided by a global positioning system (GPS), location information determined using a suitable cellular-network base-station triangulation technique, or by being associated with a Wi-Fi access point's known location. The device may then report this information to a server or other network device to relay this information on to the meeting organizer and/or other participants. Alternatively, the location may be determined remotely, for example, by a server accessing location information provided by a location service, such as one which uses satellite technology such as GPS, and/or if the device is reported as being associated with an access-point's known location by the access-point or an associated location server, and/or if the device is reported as being in a particular location using a suitable cellular network triangulation technique. Alternatively, the historical behavior of the user may have been monitored to determine a likely location of the user on different days at different times. Based upon past behavior of the user, for example, the apparatus, such as the processor, may have determined that the user is generally at work on Monday through Friday from 8:00 a.m. to 6:00 p.m. and is generally at home from 9:00 p.m. each evening until 7:00 a.m. each morning. As such, the apparatus, such as the processor, may determine the current location of the participant based upon this historical information regarding the participant's behavior.

Based upon the current location of the participant and the location of the meeting, the apparatus 10, such as the processor 12, may determine the estimated time of arrival. In this regard, the time required for a user to travel from a current location to a destination, such as the location of a meeting, may be determined by various mapping services, such as those provided by Nokia Corporation, Google Inc. or the like. As such, the apparatus, such as the processor, the communications interface 16 or the like, may interact with one or more mapping services in order to obtain the time required to travel from the current location of the participant to the meeting location and may then determine the estimated time of arrival by adding the time required to travel from the current location to the meeting location to the current time. Alternatively, the apparatus, such as the processor, may cause the user to be queried, such as via a question presented upon the display 42 of the user device that solicits user input regarding the time required to travel to the location of the meeting. Still further, the apparatus, such as the processor, may determine the current speed with which user device is moving and may then estimate the time required to travel to the meeting location based upon the current speed and the distance to the meeting location.

The historic particular mode of transport a meeting participant has taken at the time of day when the meeting is scheduled, or was previously determined to have taken to another meeting at the same location (such as a previous meeting at the same time of day and/or time of week if, for example, the meeting is a repeat meeting) may also provide an estimate of a participant's likely arrival time at the location of the meeting. In an instance in which the estimated time of arrival may be determined by several different techniques, a set of rules may govern the weighting given to the different techniques for determining the estimated time of arrival, such as in an instance in which the different techniques provide a difference in scheduled arrival time above a certain threshold. For example, if at previous meetings a participant has taken an hour from point X to arrive at the meeting, one estimate may be that if the participant is reported as being at point X 1.5 hours before the meeting that the participant will still arrive on time. However, if the participant appears to be travelling by train, and it is determined that trains on that particular line are subject to a delay such that the participant will take 50 minutes just to get to the station where the participant needs to disembark the train, then the participant is likely to be 10 minutes late if they are known to usually have a 20 minute walk after arriving at the train station to the meeting. In such circumstances, more weight may be given to the recent indication that a participant is likely to be delayed due to transportation issues than the fact that historically the participant would normally arrive early. The participant in this example may be sent an email to say that the meeting organizer and/or other participants know they may be 10 minutes late, but are currently planning to wait for them. The email in this example may also include a suggestion that the participant get a taxi from the station to reduce the delay. Advantageously, in such circumstances in which transportation issues have been identified in advance, it is also possible to send a communication to the participant to take an alternative mode of transport for the next stage of their journey, and/or to arrange for the participant to take such an alternative mode of transport. For example, a taxi may be sent to the station to wait for the late arrival of the meeting participant's train, and the late participant may receive a message to alert them not to walk but to take the waiting taxi.

In another example embodiment, the apparatus 10, such as the processor 12, may be configured to determine the mode of transportation of the participant from the current location to the meeting location. In this regard, the apparatus, such as the processor, may be configured to determine the various transportation options including walking on foot, and travelling by train, plane, automobile, bicycle or the like, and the potential sequence and duration of a sequence of such options if several modes of transportation are taken. The apparatus, such as the processor, of this embodiment may be configured to determine the time required to travel from the current location of the participant to the meeting location via each mode of transportation, such as based upon the train schedules or an average rate of travel and the distance to be traveled by automobile or by bicycle. In an example embodiment, the apparatus, such as the processor, may then determine the time required to travel from the current location to the meeting location to be the longest time from among the alternative modes of transportation and may then determine the estimated time of arrival by adding the length of time required to travel from the current location to the meeting location to the current time of day.

The apparatus 10, such as the processor 12, may be configured to update the estimated time of arrival repeatedly, such as periodically, until the participant is determined to have arrived at the meeting location. In an instance in which the apparatus, such as the processor, is configured to determine the mode of transportation and to then determine the time required to travel from the current location to the meeting location based upon the mode of transportation, the apparatus, such as the processor, may update the mode of transportation that is determined based upon additional information that may be gathered by the apparatus over the course of time. For example, the apparatus, such as the processor, may receive input from one or more sensors, such as one or more accelerometers, and based upon the additional information may determine that the participant is not traveling to the meeting location in accordance with the mode of transportation that was originally determined For example, based upon the speed at which the participant is traveling as well as the uniformity in the speed with which the participant is traveling, the apparatus, such as the processor, may determine that the participant has taken the train as opposed to having ridden a bicycle to the meeting location. As such, the apparatus, such as the processor, may redefine the current mode of transportation and, based upon the current mode of transportation, may again determine the time required to travel from the current location to the meeting location such that the estimated time of arrival of the participant may be updated.

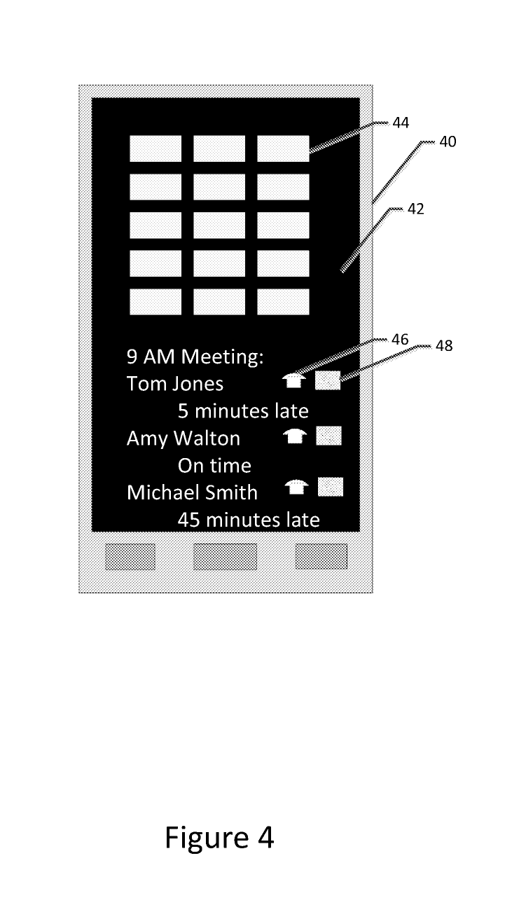

As shown in block 24 of FIG. 2, the apparatus 10 may also include means, such as the processor 12, the communications interface 16, the user interface 18 or the like, for automatically causing information relating to the estimated time of arrival of the one or more participants to be provided to another party, such as one or more other participants in the meeting and/or the meeting organizer. Of the various types of information relating to the estimated time of arrival of one or more participants that may be provided, the estimated time of arrival and, in some embodiments, the current location of a respective participant may be provided to other participants and/or the meeting organizer. By providing information relating to the estimated time of arrival for one or more participants in the meeting, the other participants in the meeting and/or the meeting organizer can quickly determine if the meeting will occur on time or will need to be delayed in order to accommodate the late arrival of one or more participants. In this regard, the estimated time of arrival may be presented upon the display 42 of the user device of one or more of the other participants in the meeting and/or the meeting organizer as shown in the lower portion of the display of FIG. 4. By providing information relating to the estimated time of arrival for one or more participants in the meeting, a determination may be made as to whether the meeting should be deferred. This determination may be made automatically by the apparatus, such as the processor, in an instance in which one or more key participants who are essential to the meeting are estimated to arrive late to the meeting. Alternatively, the apparatus, such as the processor, may issue a prompt, such as to the meeting organizer, inquiring as to whether the starting time of the meeting should be deferred, such as in an instance in which one or more non-key participants are estimated to be late to the meeting.

In an example embodiment, the apparatus 10, such as the processor 12, may cause the information relating to the estimated time of arrival to be provided on a conditional basis. For example, the apparatus, such as the processor, may only cause information relating to the estimated time of arrival to be provided for certain ones of the participants, such as one or more key participants who are required for the meeting to be conducted, but not for other ones of the participants. Additionally or alternatively, the apparatus, such as the processor, may be configured to only cause information relating to the estimated time of arrival to be provided in an instance in which the participant is estimated to arrive after the starting time of the meeting. For example, the apparatus, such as the processor, may be configured to cause the meeting organizer or one or more other participants to be alerted of the estimated time of arrival only in an instance in which a respective participant is estimated to be sufficiently late for the meeting so as to satisfy a predefined delay threshold, such as by being estimated to arrive at least a predefined period of time, e.g., 5 minutes, after the starting time of the meeting. The notification may include the information related to the estimated time of arrival and/or a visual, audible and/or vibrational alert.

The user device may be configured to present the information regarding the estimated time of arrival in various manners including concurrent with the presentation of a plurality of other icons 44 of the home or other predefined screen. In this regard, each of the other participants in the meeting are identified with an indication as to the estimated time of arrival of the respective participant with respect to the starting time of the meeting. The information that is provided regarding the estimated time of arrival may be provided in various manners, but, in an example embodiment, is provided in a manner so as to cause a ticker notification to be displayed such that the party receiving the information, such as the meeting organizer and/or the other participants in the meeting, may be provided a display of the estimated time of arrival for the one or more participants in a ticker format.

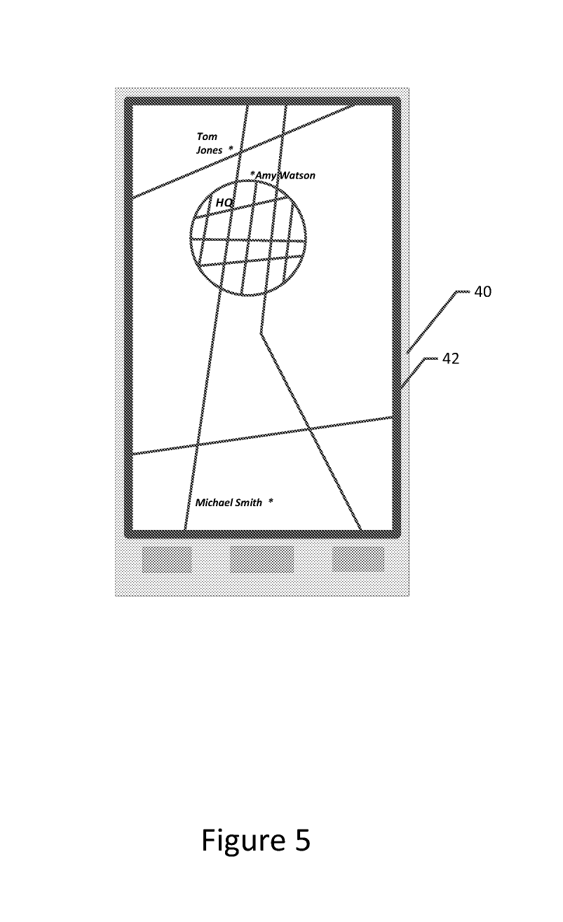

As also shown in FIG. 4, an indication 46, such as an icon, may be presented in association with the identification of at least some of the participants that, upon selection, provides for the display of contact information, e.g., telephone number, email address, etc., or otherwise initiates communication with the respective participant, such as by placing a telephone call to the participant, creating a text message or other electronic message for the respective participant or the like. The information relating to the estimated time of arrival may also include information defining a map that provides an indication of the respective location of a respective participant in a meeting. In the embodiment depicted in FIG. 4, an indication 48, such as an icon, may be provided that, upon selection, permits a map to be displayed that includes an indication of the location of the respective participant with which the map icon is associated and, in some embodiments, indications as to the respective locations of each of a plurality of participants in the meeting. In this regard, FIG. 5 depicts a map presented upon the display 42 of a mobile terminal 40. As shown, the respective locations of Tom Jones, Amy Watson and Michael Smith are depicted, as well as an indication of the location of the corporate headquarters at which the meeting is to be conducted.

The apparatus 10, such as the processor 12, may repeatedly update the information relating to the estimated time of arrival of one or more participants, such as on a periodic basis, as described above and may provide the updated information to the meeting organizer and/or one or more other participants until, for example, a condition is satisfied that terminates further notification of the estimated time of arrival of one or more participants. See block 34 of FIG. 2. Various conditions may be defined so as to terminate further notifications of the estimated time of arrival of a participant. For example, the apparatus, such as the processor, may determine that a participant has arrived at the meeting location, such as based upon the current location of the participant coinciding with the meeting location which may, in turn, cause further notifications of the estimated time of arrival of the participant to be terminated. Additionally or alternatively, the condition for termination of further notifications of the estimated time of arrival of the participants may be satisfied once the meeting time is reached. Still further, the participant may manually terminate further notifications of the estimated time of arrival. Regardless of the condition, once the condition for terminating further notifications of the estimated time of arrival of one or more participants is satisfied, such notifications may be ceased. See block 36 of FIG. 2.

In an example embodiment, one or more alternative locations for the meeting may be suggested in an instance that in which at least one of the participants is going to be late for the meeting as originally scheduled in an effort to reduce the delay associated with the meeting. In this example embodiment, the apparatus 10 may include means, such as the processor 12 or the like, for determining if the estimated time of arrival of at least one participant is later than the starting time of a meeting. See block 26 of FIG. 2. In an instance in which the estimated time of arrival of at least one participant is later than the starting time of the meeting, the apparatus may include means, such as the processor or the like, for determining one or more alternative meeting locations based on the respective locations of the participants in the meeting, that is, based upon the current locations of the participants in the meeting. See block 28. For example, the apparatus, such as the processor, may identify an alternative meeting location that will require each participant to travel for approximately the same length of time in order to permit the meeting to begin as soon as practical.

By way of example, Dr. North and Dr. South may be scheduled to attend a meeting. However, Dr. North may miss the train to the meeting location and, as such, may be estimated to arrive at the meeting location an hour late for the meeting. In response to a notification provided about an hour prior to the meeting, Dr. South may learn of Dr. North's anticipated tardiness. In an effort to reduce the delay associated with the meeting, a suggestion may be circulated to Drs. North and South that the meeting location be changed from the original meeting location, namely, the south station, to an alternative meeting location, namely, the north station at which Dr. North's train will arrive. Upon acceptance of the alternative meeting location by the participants, the meeting may be rescheduled to the north station, while maintaining the same starting time. As noted above, multiple alternative meeting locations may be provided, such as a middle station which would reduce but not eliminate the delay associated with the meeting. By rescheduling the meeting in advance, the delay associated with the meeting may be reduced and Dr. South may make efficient use of the time prior to the meeting and avoid sitting idle while waiting an hour for Dr. North to arrive.

The apparatus 10, such as the processor 12, of an example embodiment may not only consider the current locations of the participants in identifying the alternative meeting location, but may also determine the alternative meeting location based upon one or more predefined alternative meeting location candidates. The plurality of predefined alternative meeting location candidates may be differently defined depending upon the context of the meeting. For a business-related meeting to be conducted at the headquarters of a company, other local facilities owned or operated by the same company may be considered as alternative meeting location candidates. For a meeting of friends or family at a restaurant, other restaurants serving the same type of food and in the same price range may be considered as alternative meeting location candidates. From amongst the plurality of predefined alternative meeting location candidates, the apparatus, such as the processor, of this embodiment may determine which of the alternative meeting location candidates is centrally located relative to the current locations of the participants such that each of the participants could likely travel to the alternative meeting location and arrive at the earliest time relative to the anticipated arrival times at the other alternative meeting location candidates.

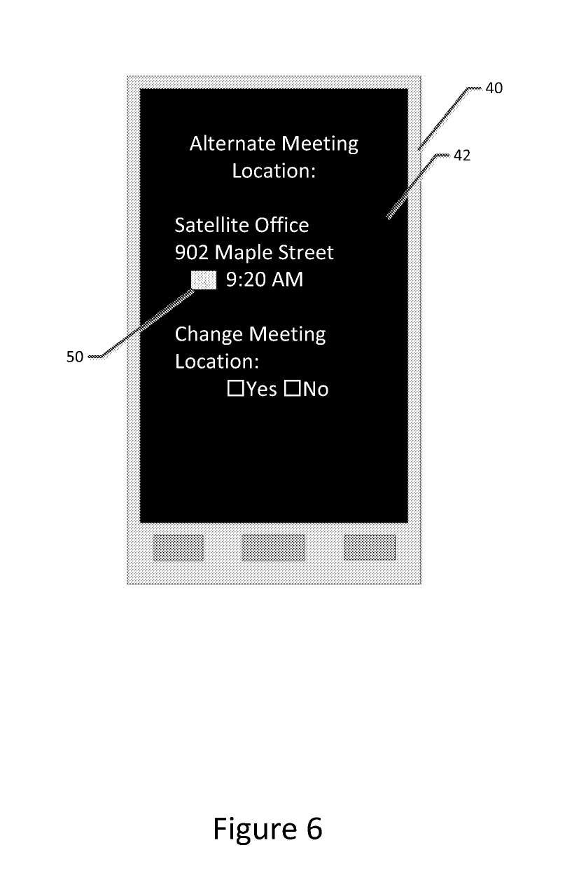

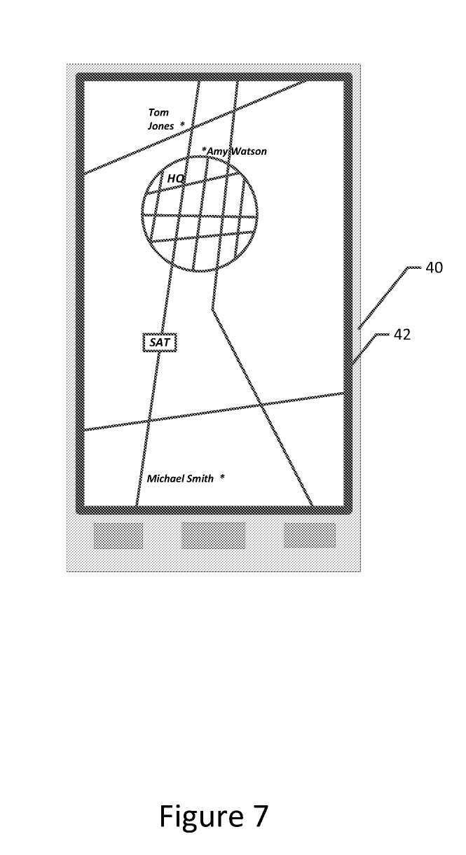

In an instance in which the apparatus 10, such as the processor 12, determines an alternative meeting location that would result in the meeting being conducted with less delay than if the meeting were to remain at the originally scheduled location, the apparatus may include means, such as the processor, the communication interface 16, the user interface 18 or the like, for causing a suggestion for the alternative meeting location to be provided to the other participants and/or the meeting organizer. See block 30 of FIG. 2. As shown in FIG. 6, for example, a window may be presented upon the display 42 of a mobile terminal 40 of a participant and/or the meeting organizer that proposes an alternative meeting location and requests a response as to the agreement of the participant or meeting organizer to change the meeting location. See block 32 of FIG. 2. In an instance in which all or, in other embodiments, a majority of the participants or at least a majority of the key participants, agree to the change in the meeting location, the meeting location may be changed and the participants and the meeting organizer may be informed of the new meeting location and time. As shown in the embodiment of FIG. 6, an indication 50, such as an icon, may be presented along with the suggestion for an alternative meeting location with the selection of the indication causing a map to be presented. As shown in FIG. 7, the map of the alternative meeting location may, in one embodiment, not only depict the alternative meeting location, but may also illustrate the current locations of each of the participants.

By providing information regarding the estimated time of arrival for one or more participants to the meeting organizer and/or other participants in the meeting, the participants may quickly determine if the meeting will start on time or be delayed. In an instance in which the meeting is determined to be delayed, the other participants may make more efficient use of their time prior to the commencement of a meeting. Additionally, the method, apparatus and computer program product of an example embodiment may facilitate the relocation of the meeting in some instances in the event that the relocation of the meeting would permit the meeting to be conducted with less delay, thereby also improving the efficiency with which the meeting may be conducted.

In some embodiments in which a user device is in a home-screen or other idle state, or when the apparatus 10 is in a state where the calendar application is open, the organizer and/or other participants designated as able to receive participant information for the meeting may be presented with a suitable widget, window, pop-up or other suitable graphical user interface element which includes graphical elements, for example, icons or tiles, provided for example, in a list or other suitable form of array, to indicate collectively the meeting participants and to provide some indication of each participant's currently estimated time of arrival for the meeting.

The designation of the arrival time of a participant may take the form of the actual estimated time of arrival being shown upon the display 42, either directly or responsive to user-input being received that selects a particular participant. Alternatively, or in addition, any other suitable visual graphical designation may be provided to represent the estimated time of arrival of a participant. In one example, an icon or text font that is utilized to identify a participant, e.g., the text font utilized to present the name of the participant, may be enlarged depending on how late a participant is currently estimated to be, such as with the names of participants who are estimated to arrive later being presented with larger font than the names of participants who are estimated to arrive on time for the meeting. In another example a color designation may be provided, as by providing a color element for each meeting participant in a suitable tile or window or pop-up or other view with the color providing an indication of whether the participant is anticipated to be late for the meeting and, if so, how late. As such, a viewer may determine at a glance whether participants are expected on time and if not, how late the participants might be simply by glancing at the color associated with each participant, such as the colored font in which the name of each participant is presented. For example, a list of participants may take the form of an array of graphical elements such as icons or tiles, each graphical element representing a respective participant. A hue component of a graphical element for a participant may indicate how late that participant estimated to be for the meeting. For example, the border or background element of a graphical element may be colored in a particular hue to indicate the estimated delay or a span or range of estimated delay times for which the participant is currently estimated to be possibly delayed. For example, a red border or background element may indicate that the participant is expected to be more than 10 minutes late, orange may be used in the border or background to indicate a user is to be 5 to 10 minutes late, yellow if they may be 0 to 5 minutes late, and green if they are likely to be on-time to the meeting. Any suitable form of color scheme or list format may be used, including, for example, scrollable lists (or automatically or inertially scrolling lists or arrays), and any suitable graphical element form of presenting participants and indicating their estimated arrival time may be provided. For example, if participants are shown as names in a tiled list, the border or background color of the tile and/or the color of any text indicating the participant may be used to indicate if that participant may be late. The bounds for arrival time estimates to change color may be configurable by the meeting organizer and/or be provided as a setting.

As described above, FIG. 2 illustrates a flowchart of an apparatus 10, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus employing an embodiment of the present invention and executed by a processor 12 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included as indicated, for example, by the blocks having a dashed outline in FIG. 2. Additionally, although not described above, the apparatus may include means, such as the processor, the communications interface, the user interface or the like, for causing a notification to provided to a participant in advance of a meeting so as to remind the participant of the upcoming meeting. The reminder may be initially provided a predetermined time in advance of the meeting with the predetermined time being defined, for example, by a user configurable setting. Alternatively, the reminder may be initially provided at a time that is based upon the estimated time to travel to the meeting location, such as by providing the initial notification a predetermined time in advance of the meeting as defined by the sum of the estimated time to travel to the meeting location and a predefined lead time. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims Although specific terms are employed herein, they are used in a generic and descriptive sense only and not for purposes of limitation.

1-36. (canceled)

37. An apparatus comprising a processor and a memory including computer program code, the memory and the computer program code configured to, with the processor, cause the apparatus to:
present, on a display, information associated with a meeting, the information comprises an identification of one or more participants to the meeting;
determine an estimated time of arrival for at least one of the one or more participants to the meeting; and
automatically cause information relating to the estimated time of arrival of the at least one of the one or more participants to be provided to another device.

38. An apparatus according to claim 37 wherein the memory and the computer program code are configured to, with the processor, cause the apparatus to determine an estimated time of arrival by determining the estimated time of arrival for each of the one or more participants based upon a current location of the respective participant and based upon a mode of transportation for the respective participant.

39. An apparatus according to claim 37 wherein the memory and the computer program code are configured to, with the processor, cause the apparatus to automatically cause information relating to the estimated time of arrival to be provided by causing information configured to cause a ticker notification to be displayed to be provided to the another device.

40. An apparatus according to claim 37 wherein the memory and the computer program code are configured to, with the processor, cause the apparatus to automatically cause information relating to the estimated time of arrival to be provided by causing information defining a map including indications of respective locations of the one or more participants to be provided to the another device.

41. An apparatus according to claim 37 wherein the memory and the computer program code are configured to, with the processor, cause the apparatus to automatically cause information relating to the estimated time of arrival to be provided only in an instance in which the estimated time of arrival satisfies a predefined delay threshold.

42. An apparatus according to claim 37 wherein the memory and the computer program code are further configured to, with the processor, cause the apparatus to cause a suggestion for an alternative meeting location to be provided to the another device in an instance in which the estimated time of arrival of a participant is later than a starting time of the meeting.

43. An apparatus according to claim 42 wherein the memory and the computer program code are further configured to, with the processor, cause the apparatus to determine the alternative meeting location based upon respective locations of the participants in the meeting.

44. A method comprising:
presenting, on a display, information associated with a meeting, the information comprises an identification of one or more participants to the meeting;
determining, by one or more computing devices, an estimated time of arrival for at least one of the one or more participants to the meeting; and
automatically causing, by the one or more computing devices, information relating to the estimated time of arrival of the at least one of the one or more participants to be provided to another device.

45. A method according to claim 44 wherein determining, by one or more computing devices, an estimated time of arrival comprises determining the estimated time of arrival for each of the one or more participants based upon a current location of the respective participant and a mode of transportation for the respective participant.

46. A method according to claim 44 wherein automatically causing, by the one or more computing devices, information relating to the estimated time of arrival to be provided comprises:
causing information configured to cause a ticker notification to be displayed to be provided to the another device y; and
causing information defining a map including indications of respective locations of the one or more participants to be provided to the another device.

47. A method according to claim 44 wherein automatically causing, by the one or more computing devices, information relating to the estimated time of arrival to be provided is performed only in an instance in which the estimated time of arrival satisfies a predefined delay threshold.

48. A method according to claim 44 further comprising causing, by the one or more computing devices, a suggestion for an alternative meeting location to be provided to the another device in an instance in which the estimated time of arrival of a participant is later than a starting time of the meeting.

49. A method according to claim 48 further comprising determining, by the one or more computing devices, the alternative meeting location based upon respective locations of the participants in the meeting.

50. A non-transitory computer readable medium having program code portions stored thereon, the program code portions configured, upon execution, to:
present, on a display, information associated with a meeting, the information comprises an identification of one or more participants to the meeting;
determine an estimated time of arrival for at least one of the one or more participants to the meeting; and
automatically cause information relating to the estimated time of arrival of the at least one of the one or more participants to be provided to another device.

51. A non-transitory computer readable medium according to claim 50 wherein the program code portions configured to determine an estimated time of arrival comprise program code portions configured to determine the estimated time of arrival for each of the one or more participants based upon a current location of the respective participant and a mode of transportation for the respective participant.

52. A non-transitory computer readable medium according to claim 50 wherein the program code portions configured to automatically cause information relating to the estimated time of arrival to be provided comprise program code portions configured to cause information configured to cause a ticker notification to be displayed to be provided to the another device.

53. A non-transitory computer readable medium according to claim 50 wherein the program code portions configured to automatically cause information relating to the estimated time of arrival to be provided comprise program code portions configured to cause information defining a map including indications of respective locations of the one or more participants to be provided to the another device.

54. A non-transitory computer readable medium according to claim 50 wherein the program code portions are configured to automatically cause the information relating to the estimated time of arrival to be provided only in an instance in which the estimated time of arrival satisfies a predefined delay threshold.

55. A non-transitory computer readable medium according to claim 50 wherein the program code portions are further configured to cause a suggestion for an alternative meeting location to be provided to the another device in an instance in which the estimated time of arrival of a participant is later than a starting time of the meeting.

56. A non-transitory computer readable medium according to claim 55 wherein the program code portions are further configured to determine the alternative meeting location based upon respective locations of the participants in the meeting.
